(19) United States
(12) Patent Application Publication
(10) Pub. No.: US 2013/0328818 A1
(43) Pub. Date: Dec. 12, 2013

(54) INFORMATION PROCESSING APPARATUS AND INFORMATION PROCESSING METHOD, RECORDING MEDIUM, AND PROGRAM

(71) Applicant: Tatsuya Igari, Tokyo (JP)

(72) Inventor: Tatsuya Igari, Tokyo (JP)

(73) Assignee: Sony Corporation, Tokyo (JP)

(21) Appl. No.: 14/000,422

(22) PCT Filed: Mar. 22, 2012
(86) PCT No.: PCT/JP2012/001977

§ 371 Date: Aug. 20, 2013

(30) Foreign Application Priority Data
Mar. 29, 2011 (JP) 2011-072377

(51) Int. Cl. G06F 3/041

(52) U.S. Cl. CPC G06F 3/041
USPC 345/173

(57) ABSTRACT

A user interface apparatus provides multiple touch panels coupled to a processor and operating as a single touch panel. Multiple touch inputs can be provided to the multiple touch panels. The touch panels provide spatial and temporal touch information to the processor such that the touch inputs are reliably analyzed by the processor, even when a predetermined maximum touch count is imposed.

This application claims priority from Japanese Patent Application JP2011-072377, filed Mar. 29, 2011, the disclosure of which is hereby expressly incorporated by reference.

### TECHNICAL FIELD

The present disclosure relates to an information processing apparatus and an information processing method, a recording medium, and a program, and more specifically relates to an information processing apparatus and an information processing method, a recording medium, and a program, which make it possible to execute processing reliably.

### BACKGROUND ART

There have been proposed multi-touch technologies with which a plurality of points on a touch screen are touched simultaneously to execute a predetermined operation.

For example, Patent Document 1 describes that whether or not to execute an operation by multi-touch on a multi-touch display is determined on the basis of whether a multi-touch flag is set or unset.

By switching between setting and unsetting of a multi-touch flag for each software, an operation can be executed without differentiating between software that employs multi-touch and software that does not employ multi-touch.

### CITATION LIST

### Patent Document

Patent Document 1: Japanese Unexamined Patent Application Publication No. 2009-211704

### DISCLOSURE OF INVENTION

### Technical Problem

However, in the invention according to Patent Document 1, whether or not to execute multi-touch is determined on a single multi-touch display.

For this reason, no consideration has been given to how to process multi-touch information detected by each multi-touch display in a case where a plurality of multi-touch displays are combined to execute a predetermined operation.

Therefore, in the invention according to Patent Document 1, there is a risk that the user may not be able to execute desired processing in a case where a plurality of multi-touch displays are handled as a single multi-touch display.

The present disclosure has been made in view of the above circumstances, and makes it possible to execute processing reliably.

### Technical Solution

### Summary

In one aspect, the invention provides a method for identifying a subset of touch positions. The method comprises receiving, from a first touch input device, first touch information comprising first positional information identifying one or more first device positions touched by a user; receiving, from a second touch input device, second touch information comprising second positional information identifying one or more second device positions touched by the user; identifying, based on the first and second touch information, a subset of the first and second device positions as detected positions; and sending detection information identifying the detected positions to an application.

In another aspect, the invention provides an apparatus for providing a user interface, comprising a hardware processor and a memory coupled to the processor and containing instructions. The instructions, when executed by the processor, cause the apparatus to receive, from a first touch input device, first touch information comprising first positional information identifying one or more first device positions touched by a user; receive, from a second touch input device, second touch information comprising second positional information identifying one or more second device positions touched by the user; identify, based on the first and second touch information, a subset of the first and second device positions as detected positions; and send detection information identifying the detected positions to an application.

In yet another aspect, the invention provides a non-transitory, computer-readable medium storing instructions which, when executed by a processor, cause a user interface to perform a method. The method comprises receiving, from a first touch input device, first touch information comprising first positional information identifying one or more first device positions touched by a user; receiving, from a second touch input device, second touch information comprising second positional information identifying one or more second device positions touched by the user; identifying, based on the first and second touch information, a subset of the first and second device positions as detected positions; and sending detection information identifying the detected positions to an application.

According to an aspect of the present disclosure, it is possible to execute processing reliably.

### BRIEF DESCRIPTION OF DRAWINGS

FIG. 1 is a diagram showing an example of input of a touch panel to which the present disclosure is not applied.

FIG. 2 is a diagram showing an example of input of a touch panel to which the present disclosure is not applied.

FIG. 3 is a diagram showing an example of input of a touch panel to which the present disclosure is not applied.

FIG. 4 is a block diagram showing an example of the hardware configuration of a personal computer to which the present disclosure is applied.

FIG. 5 is a block diagram showing an example of the functional configuration of a CPU.

FIG. 6 is a diagram showing an overview of processing by software.

FIG. 7 is a diagram showing an example of input of a touch panel.

FIG. 8 is a diagram showing an example of output of a touch panel.

FIG. 9 is a flowchart illustrating a touch information selection process.

FIG. 10 is a diagram showing an example of input and output of a touch panel.

FIG. 11 is a diagram showing an example of input of a touch panel.

FIG. 12 is a flowchart illustrating an upper-side rearrangement process.

FIG. 13 is a flowchart illustrating an upper-side selection process.

FIG. 14 is a diagram showing an example of output of a touch panel.

FIG. 15 is a diagram showing an example of input of a touch panel.

FIG. 16 is a flowchart illustrating a lower-side rearrangement process.

FIG. 17 is a flowchart illustrating a lower-side selection process.

FIG. 18 is a diagram showing an example of output of a touch panel.

FIG. 19 is a diagram showing an example of processing by an application.

### BEST MODE FOR CARRYING OUT THE INVENTION

Hereinbelow, a mode for carrying out the present disclosure (hereinafter, referred to as embodiment) will be described. It should be noted that the description will be given in the following order.

1. Example of a touch panel to which the present disclosure is not applied

2. Configuration of a personal computer

3. Touch information selection process

4. Upper-side rearrangement process

5. Upper-side selection process

6. Lower-side rearrangement process

7. Lower-side selection process

8. Others

[Example of a Touch Panel to which the Present Disclosure is Not Applied]

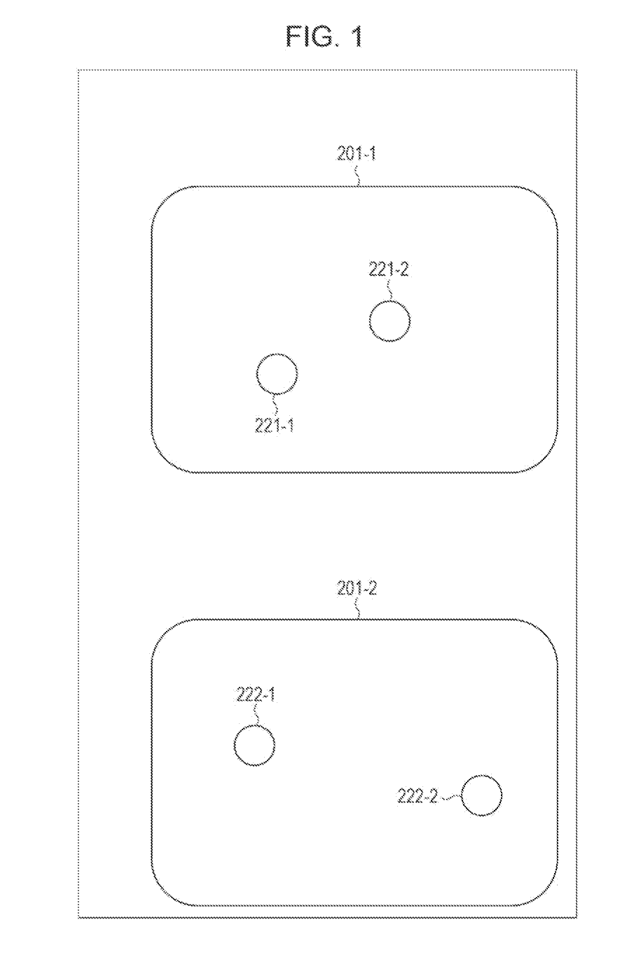

FIG. 1 is a diagram showing an example of a touch panel 201 in a case where the present disclosure is not applied. The example of FIG. 1 shows a state in which the user has touched predetermined positions on a touch panel 201-1 on the upper side and a touch panel 201-2 on the lower side.

It should be noted that the touch panels 201-1 and 201-2 will be hereinafter simply written as touch panel 201 in cases where there is no need to individually distinguish these touch panels from each other. The same applies to other components as well.

The touch panel 201 is a touch panel display that is capable of multi-touch. The user can input a predetermined operation by touching a plurality of points on the touch panel 201.

For example, when the user touches two predetermined points on the touch panel 201-1 on the upper side, the touch panel 201-1 on the upper side detects the touched points. In the example of FIG. 1, upper-side touch points 221-1 and 221-2 are detected by the touch panel 201-1 on the upper side.

Then, for example, as the user moves two fingers touching the touch panel 201-1 on the upper side toward or away from each other, shrinking or enlarging of an image displayed on the touch panel 201-1 on the upper side is executed as predetermined processing.

The same processing is executed for the touch panel 201-2 on the lower side as well. In this way, the touch panel 201 can execute an operation using multi-touch.

However, although it is possible to detect multi-touch by each of the touch panels 201-1 and 201-2, it is difficult to detect multi-touch while combining and regarding the touch panels 201-1 and 201-2 as a single touch panel.

This is because information on each of touch points on the touch panel 201-1 on the upper side and the touch panel 201-2 on the lower side is accepted independently by an unillustrated controller of the touch panel 201.

That is, the controller accepts information on each touch point on the touch panel 201-1 at a first timing by an interrupt process, and accepts information on each touch point on the touch panel 201-2 at a second timing by an interrupt process.

For this reason, when the user touches both the upper-side touch point 221-1 on the touch panel 201-1 on the upper side, and the lower-side touch point 222-1 on the touch panel 201-2 on the lower side, information on the upper-side touch point 221-1 and information on the lower-side touch point 222-1 are alternately accepted by the controller.

That is, after information on the upper-side touch point 221-1 is accepted from the touch panel 201-1 on the upper side, information on the lower-side touch point 222-1 is accepted from the touch panel 201-2 on the lower side. Then, once again, information on the upper-side touch point 221-1 is accepted, and the same processing is subsequently repeated.

Therefore, by the controller, the touch panel 201-1 on the upper side and the touch panel 201-2 on the lower side are detected as being alternately touched, and the fact that the distance between the upper-side touch point 222-1 and the lower-side touch point 222-1 is increasing or decreasing is not detected.

As a result, predetermined processing such as enlarging or shrinking of an image described above cannot be executed.

Further, even if processing can be performed while regarding the upper-side touch point 222-1 and the lower-side touch point 222-1 as being detected simultaneously, that is, while regarding the touch panel 201-1 on the upper side and the touch panel 201-2 on the lower side as a single touch panel, there is a risk that the maximum detection count of touch points (i.e., a predetermined value) may be exceeded.

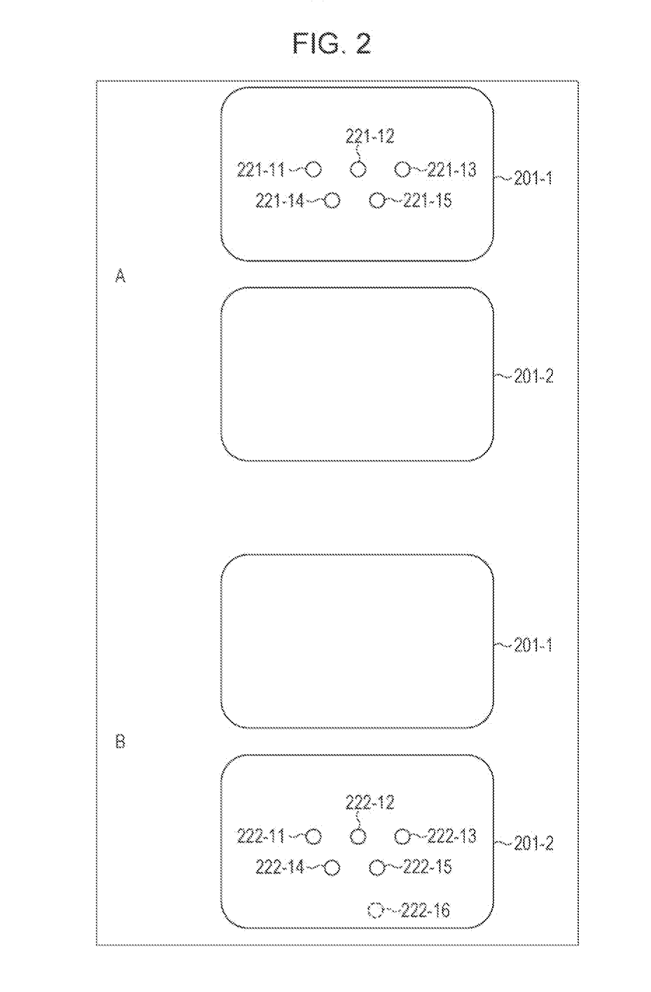

FIG. 2 is a diagram showing an example of input of the touch panel 201. A maximum detection count indicating the maximum number of touch points that can be detected is set for software that controls the touch panel 201.

It should be noted that the maximum detection count for the software that controls the touch panel 201 will hereinafter be simply written as maximum detection count for the touch panel 201.

FIG. 2 shows a case where the maximum detection count is 5, that is, a case where the number of fingers on one hand of the user is set as the maximum detection count.

In A of FIG. 2, a case is shown in which the touch panel 201-1 on the upper side detects upper-side touch points 221-11 to 221-15. The touch panel 201-2 on the lower side is not touched.

In B of FIG. 2, a case is shown in which the touch panel 201-2 on the lower side detects lower-side touch points 222-11 to 222-16. The touch panel 201-1 on the upper side is not touched.

As shown in A of FIG. 2, when the number of upper-side touch points 221 detected by the touch panel 201-1 on the upper side is 5, the number of upper-side touch points 221 does not exceed 5 that is the maximum detection count for the touch panel 201-1 on the upper side.

Therefore, on the touch panel 201-1 on the upper side, the upper-side touch points 221-11 to 221-15 are detected and displayed.

On the other hand, as shown in B of FIG. 2, when the number of lower-side touch points 222 touched by the user on the touch panel 201-2 on the lower side is 6, the number of lower-side touch points 222 exceeds 5 that is the maximum detection count for the touch panel 201-2 on the lower side.

In this case, the last touched lower-side touch point 222 is not detected. For example, in a case where the lower-side touch point 222-16 is touched last after the lower-side touch points 222-11 to 222-15 are touched, the lower-side touch point 222-16 is not detected.

In the case of B of FIG. 2, the lower-side touch point 222-16 not detected as having been touched is indicated by a broken line.

Therefore, as shown in B of FIG. 2, on the touch panel 201-2 on the lower side, the lower-side touch points 222-11 to 222-15 are displayed in solid lines, and the lower-side touch point 222-16 is displayed in the broken line.

In this way, when the maximum detection count is exceeded, the touch panel 201 does not detect any touch point touched after the maximum detection count is exceeded.

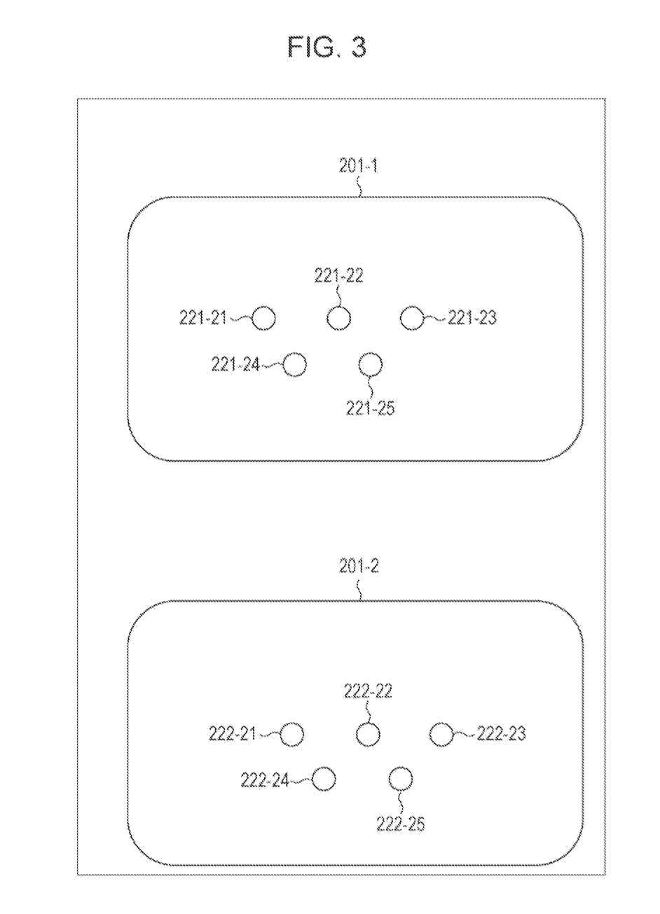

However, in the case of executing processing while handling the touch panel 201-1 on the upper side and the touch panel 201-2 on the lower side as a single touch panel, there is a risk that a number of touch points exceeding the maximum detection count may be detected. Referring to FIG. 3, a description will be given of a case where the number of touch points exceeds the maximum detection count.

FIG. 3 is a diagram showing an example of input of the touch panel 201.

In the case of FIG. 3, the touch panel 201-1 on the upper side and the touch panel 201-2 on the lower side are handled as a single touch panel. Therefore, the maximum detection count is 5 for the touch panel 201-1 on the upper side and the touch panel 201-2 on the lower side combined together.

However, the touch panel 201-1 on the upper side and the touch panel 201-2 on the lower side detect touch points independently.

Therefore, as shown in FIG. 3, a situation is conceivable in which five upper-side touch points 221-21 to 221-25 are detected by the touch panel 201-1 on the upper side, and five lower-side touch points 222-21 to 222-25 are detected by the touch panel 201-2 on the lower side.

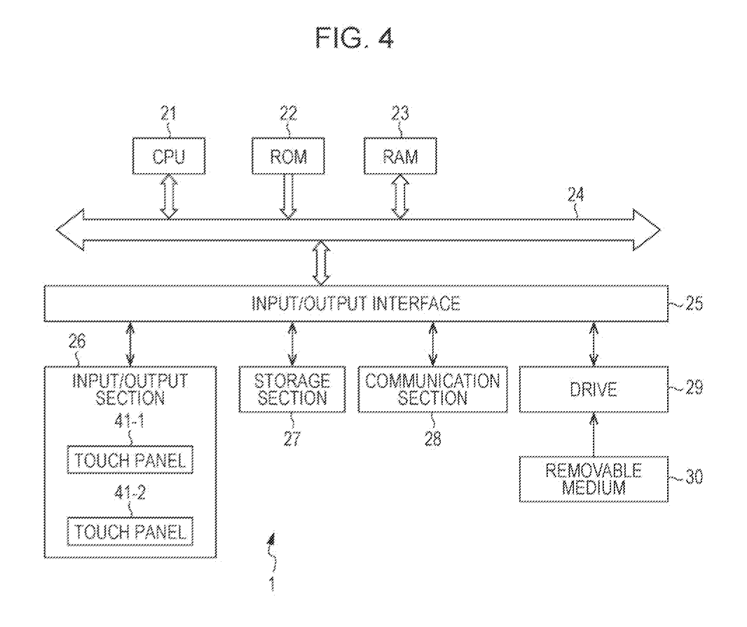

That is, a total of 10 touch points are detected, with the result that the number of detected touch points exceeds the maximum detection count of 5. Referring to FIG. 4, an example of the configuration of a personal computer according to this embodiment for solving the above problem is shown.

### [Configuration of a Personal Computer]

FIG. 4 is a block diagram showing an example of the hardware configuration of a personal computer 1 as an information processing apparatus according to this embodiment.

In the personal computer 1, a CPU (Central Processing Unit) 21, a ROM (Read Only Memory) 22, and a RAM (Random Access Memory) 23 are connected to each other via a bus 24.

The bus 24 is further connected with an input/output interface 25. The input/output interface 25 is connected with an input/output section 26, a storage section 27, a communication section 28, and a drive 29.

In addition to having touch panels 41-1 and 41-2, the input/output section 26 includes a keyboard, a mouse, a microphone, a display, a speaker, or the like. The storage section 27 is formed by a hard disk, a non-volatile memory, or the like.

It should be noted that the touch panel 41 in this specification is formed by integrating a touch panel as an input device, and a display such as an LCD (Liquid Crystal Display) as an output device.

That is, the touch panel 41 has two functions of input and output. The touch panel 41 detects touch information such as information about a position on the screen touched by a user's finger, a pen, or the like, and also displays predetermined image information or the like.

The communication section 28 is formed by a network interface or the like. The drive 29 drives a removable medium 30 such as a magnetic disc, an optical disc, a magneto-optical disc, or a semiconductor memory.

In the personal computer 1 configured as mentioned above, various kinds of processing are performed as the CPU 21 loads a program stored in the storage section 27 into the RAM 23 via the input/output interface 25 and the bus 24, and executes the program, for example.

The program to be executed by the CPU 21 is provided while being recorded on the removable medium 30 in the form of a packaged medium or the like (i.e., a tangible, non-transitory, computer-readable storage medium), for example.

It should be noted that as the packaged medium, a magnetic disc (including a flexible disc), an optical disc (such as a CD-ROM (Compact Disc-Read Only Memory) or a DVD (Digital Versatile Disc)), a magneto-optical disc, a semiconductor memory, or the like is used.

Also, the program can be provided via a wired or wireless transmission medium such as a local area network, the Internet, or digital satellite broadcast.

In the personal computer 1, the program can be installed into the storage section 27 via the input/output interface 25 by mounting the removable medium 30 in the drive 29.

Also, the program can be received by the communication section 28 via a wired or wireless transmission medium, and installed into the storage section 27. Alternatively, the program can be pre-installed in the ROM 22 or storage section 27.

It should be noted that the program executed by the personal computer 1 may execute processes in a time-series fashion in the order as described in this specification, or may execute processes in parallel or at necessary timing such as when invoked.

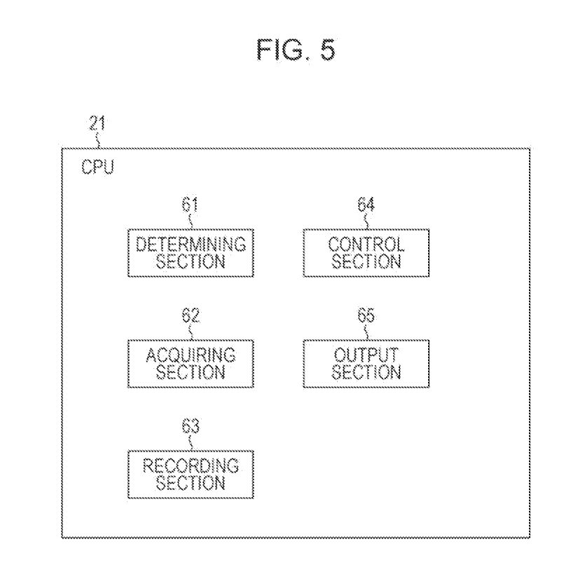

FIG. 5 is a block diagram showing an example of the functional configuration of the CPU 21.

The CPU 21 has the functional blocks of a determining section 61, an acquiring section 62, a recording section 63, a control section 64, and an output section 65. It should be noted that the individual blocks of the CPU 21 are able to exchange signals or data with each other as necessary.

The determining section 61 determines various kinds of information. The acquiring section 62 acquires various kinds of information. The recording section 63 records various kinds of information. The control section 64 performs various kinds of control processing. The output section 65 outputs various kinds of information.

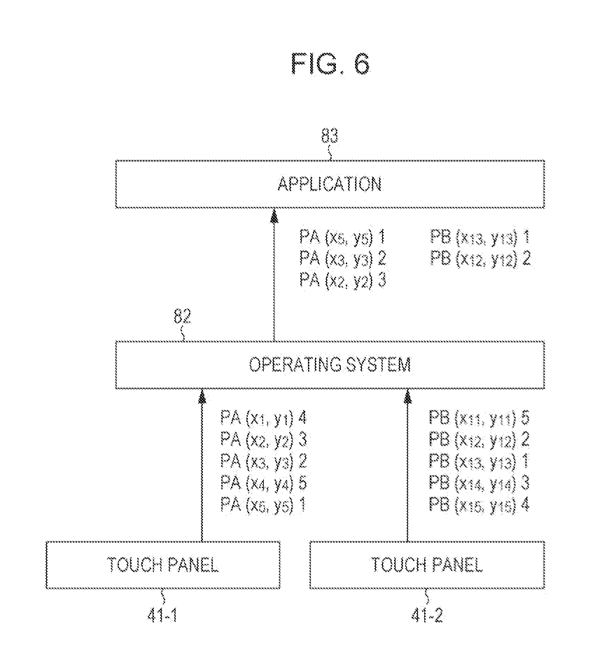

FIG. 6 is a diagram showing an overview of processing by software associated with control of the personal computer 1. The software includes an operating system 82 and an application 83, and is controlled by the control section 64.

The touch panel 41 outputs detected touch information to the operating system 82. The touch information is, for example, positional information for each of touch points touched by the user, information for identifying the order in which each touch point is touched (for example, time information or ID (Identification)), or the like.

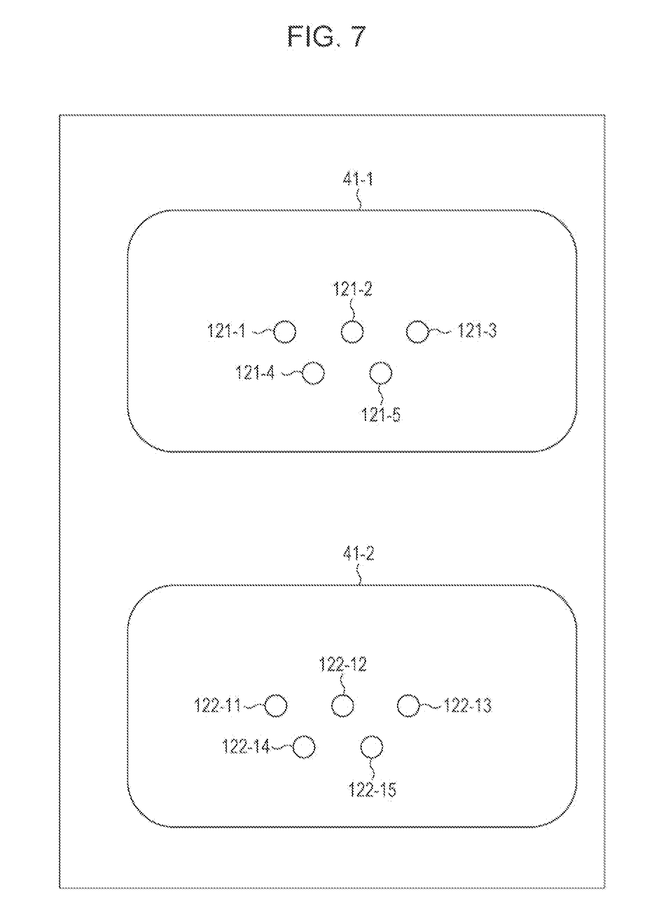

Referring to FIG. 7, a description will be given of a case where the touch panel 41 detects touch points.

FIG. 7 is a diagram showing an example of input of the touch panel 41.

For example, as shown in FIG. 7, when the user touches five points on each of the touch panel 41-1 and the touch panel 41-2, upper-side touch points 121-1 to 121-5 (i.e., first device positions) are detected by the touch panel 41-1 on the upper side, and lower-side touch points 122-11 to 122-15 (i.e., second device positions) are detected by the touch panel 41-2 on the lower side.

Then, information on each of the detected upper-side touch points 121-1 to 121-5 (i.e., first positional information) and information on each of the detected lower-side touch points 122-11 to 122-15 (i.e., second positional information) are outputted as touch information from the touch panels 41-1 and 41-2 to the operating system 82.

The touch information is expressed in the form of, for example, “PA(x₁, y₁)4, PA(x₂, y₂)3, PA(x₃, y₃)2, PA(x₄, y₄)5, and PA(x₅, y₅)1” as shown in FIG. 6.

“PA” indicates that a touch point lies on the touch panel 41-1 on the upper side. That is, this indicates that a touch point is detected by the touch panel 41-1 on the upper side. Likewise, “PB” indicates that a touch point is detected by the touch panel 41-2 on the lower side.

“(xₐ, yₐ) (a is a natural number)” indicates the coordinates of a touch point. That is, this indicates positional information on a touch point touched on the touch panel 41 by the user.

It should be noted that “(xₐ, yₐ)” indicates the coordinates of an upper-side touch point 121-a or lower-side touch point 122-a (i.e., first or second spatial coordinates). That is, “PA(x₁, y₁)4” indicates the coordinates of the upper-side touch point 121-1.

The number following the positional information on a touch point indicates the order in which each touch point is touched (i.e., time information), and the smaller the number, the earlier the touch point is touched. This number is, for example, a number such as an ID, and appended to information on each of touch points in the order of being touched.

For example, of “PA(x₁, y₁)4” and “PA(x₂, y₂)3”, “PA(x₂, y₂)3” is the touch point that is touched earlier. That is, the upper-side touch point 121-2 is touched earlier than the upper-side touch point 121-1.

The operating system 82 executes a process of acquiring touch information from the touch panel 41 and selecting (i.e., identifying) a number of touch points equal to or less than the maximum detection count (i.e., a subset of the first and second device positions), and outputs the detection information, that is, information on each of the selected touch points, to the application 83.

It should be noted that the example of FIG. 6 illustrates a case where the maximum detection count is 5. Hereinafter, the same applies to the examples of other drawings as well.

In the example of FIG. 6, the operating system 82 acquires “PA(x₁, y₁)4, PA(x₂, y₂)3, PA(x₃, y₃)2, PA(x₄, y₄)5, and PA(x₅, y₅)1” as touch information from the touch panel 41-1.

Also, the operating system 82 acquires “PB(x₁₁, y₁₁)5, PB(x₁₂, y₁₂) 2, PB(x₁₃, y₁₃) 1, PB(x₁₄, y₁₄)3, and PB(x₁₅, y₁₅) 4” as touch information from the touch panel 41-2.

The operating system 82 having acquired the touch information executes a process of selecting a number of touch points equal to or less than the maximum detection count, and outputs the selected upper-side detection information and lower-side detection information to the application 83.

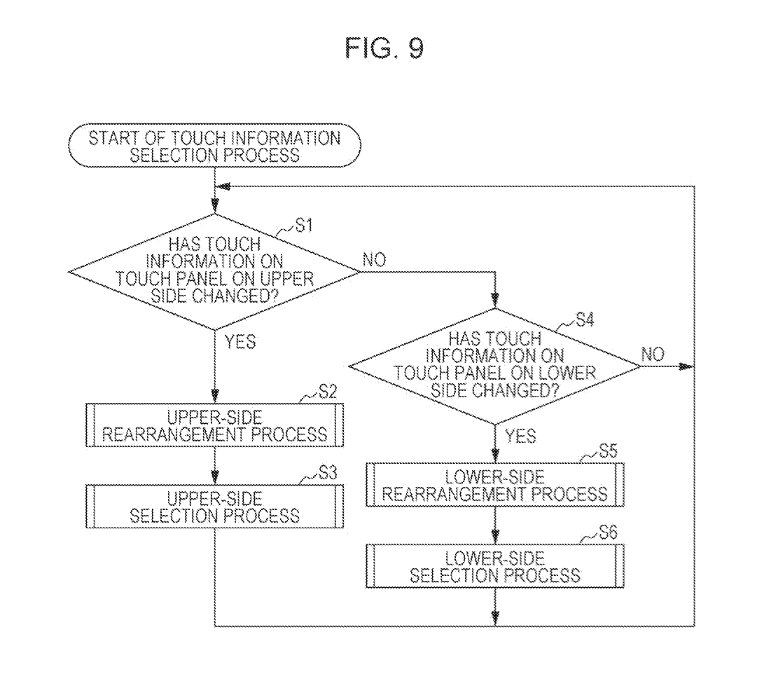

The process of selecting a number of touch points equal to or less than the maximum detection count by the operating system 82, that is, processing in the personal computer 1 will be described later with reference to FIG. 9. The touch points are selected in order from the touch point that is touched earliest.

It should be noted that as touch information, information on each of touch points is basically acquired in the order of being touched. However, in cases such as when touches occur simultaneously within a short period of time, information on each of touch points may not necessarily be acquired in the order of being touched as shown in FIG. 6.

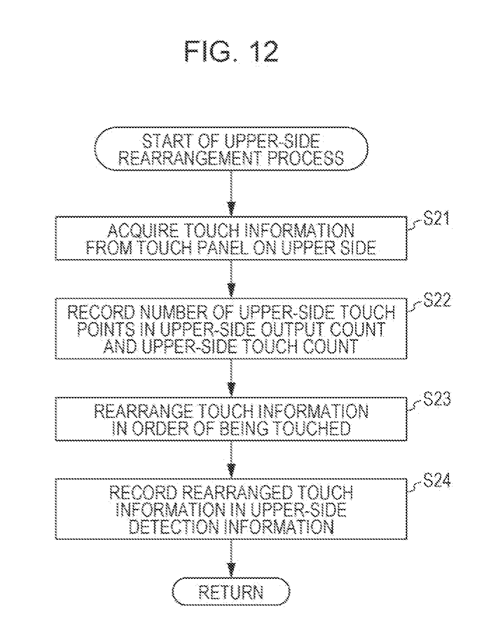

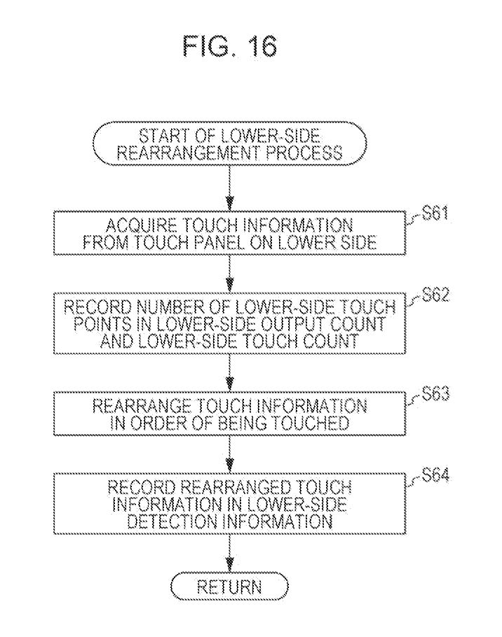

In such cases, it is necessary to rearrange the order of touch points. The rearrangement process will be described later with reference to FIGS. 12 and 16.

In the example of FIG. 6, “PA(x₅, y₅)1, PA(x₃, y₃)2, and PA(x₂, y₂)3” are selected as upper-side detection information, and “PB(x₁₃, y₁₃)1 and PB(x₁₂, y₁₂)2” are selected as lower-side detection information.

This is because “PA(x₅, y₅)1, PA(x₃, y₃)2, and PA(x₂, y₂)3” are touched earliest, and “PB(x₁₃, y₁₃)1 and PB(x₁₂, y₁₂)2” are earlier in time than “PA(x₁, y₁)4 and PA(x₄, y₄)5”.

That is, the five earliest touch points in time are selected from among both the touch panel 41-1 and the touch panel 41-2.

Then, the upper-side detection information and the lower-side detection information are outputted to the application 83.

That is, information on each of touch points detected by the touch panel 41-1 on the upper side, and information on each of touch points detected by the touch panel 41-2 on the lower side are outputted to the application 83, as touch information detected by a single touch panel.

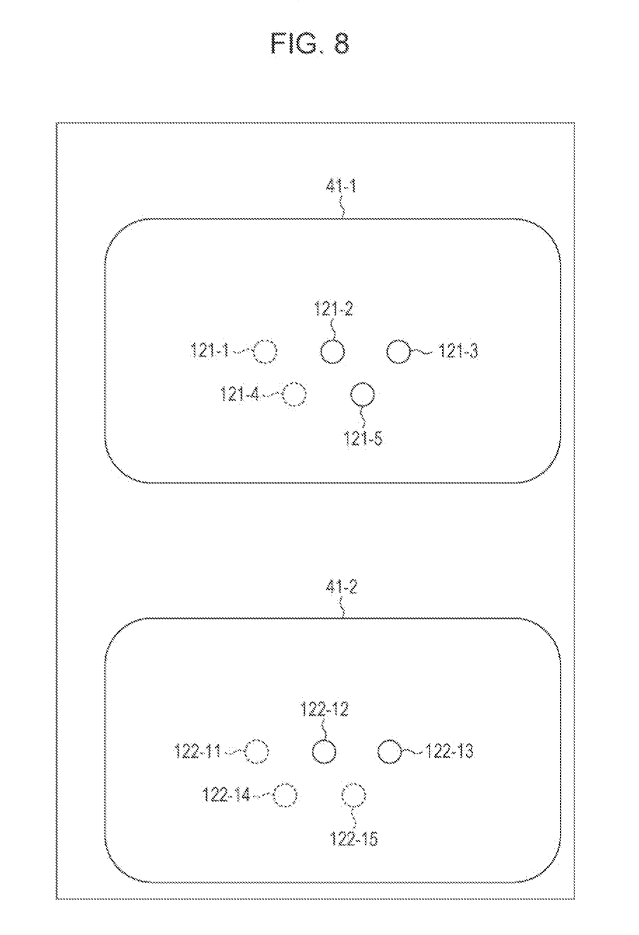

The application 83 executes predetermined processing on the basis of the upper-side detection information and the lower-side detection information acquired from the operating system 82. Referring to FIG. 8, a description will be given of a case where touch points included in the upper-side detection information and lower-side detection information are outputted to the touch panel 41.

FIG. 8 is a diagram showing an example of output corresponding to the input of the touch panel 41 in FIG. 7. In the example of FIG. 8, the upper-side touch points 121-2, 121-3, and 121-5 are indicated by solid lines, and the upper-side touch points 121-1 and 121-4 are indicated by broken lines on the touch panel 41-1 on the upper side.

That is, as shown in FIG. 6, the upper-side touch points 121-2, 121-3, and 121-5 corresponding to the upper-side detection information “PA(x₅, y₅)1, PA(x₃, y₃)2, and PA(x₂, y₃)3” acquired by the application 83 are displayed on the touch panel 41-1 on the upper side.

On the other hand, touches on the upper-side touch points 121-1 and 121-4 are ignored, and are not displayed on the touch panel 41-1 on the upper side.

Likewise, in the example of FIG. 8, on the touch panel 41-2 on the lower side, the lower-side touch points 122-12 and 122-13 are indicated by solid lines, and the lower-side touch points 122-11, 122-14, and 122-15 are indicated by broken lines.

That is, as shown in FIG. 6, the lower-side touch points 122-12 and 122-13 corresponding to the lower-side detection information “PB(x₁₃, y₁₃)1 and PB(x₁₂, y₁₂)2” acquired by the application 83 are displayed on the touch panel 41-2 on the lower side.

On the other hand, touches on the lower-side touch points 122-11, 122-14, and 122-15 are ignored, and are not displayed on the touch panel 41-2 on the lower side.

Thus, the operating system 82 can execute predetermined processing by combining and handling the touch panel 41-1 on the upper side and the touch panel 41-2 on the lower side as a single touch panel.

Moreover, even when a number of touch points exceeding the maximum detection count are detected, the operating system 82 executes predetermined processing by selecting a number of pieces of touch information equal to or less than the maximum detection count.

While the example of FIG. 6 is directed to the case where the operating system 82 executes a process of selecting a number of touch points equal to or less than the maximum detection count, the process may be executed by any one of a device driver within the operating system 82, a layer of the operating system 82 other than the device driver, and middleware.

Also, the same process may be executed not only by the operating system 82 but by the application 83.

### [Touch Information Selection Process]

Referring to FIGS. 9 to 19, a touch information selection process by the personal computer 1 will be described.

FIG. 9 is a flowchart illustrating the touch information selection process by the personal computer 1. The touch information selection process in FIG. 9 is started when the personal computer 1 is activated, and is thereafter executed continuously.

In step S1, the determining section 61 determines whether or not touch information on the touch panel 41-1 on the upper side has changed. That is, it is determined whether or not the number of upper-side touch points 121 on the touch panel 41-1 on the upper side has increased or decreased.

If the number of upper-side touch points 121 on the touch panel 41-1 on the upper side has not increased or decreased, the determining section 61 determines whether or not touch information on the touch panel 41-2 on the lower side has changed.

If the number of lower-side touch points 122 on the touch panel 41-2 on the lower side has not increased or decreased, the processing returns to step S1. That is, if the number of touch points does not change, the processes of steps S1 and S4 are repeated.

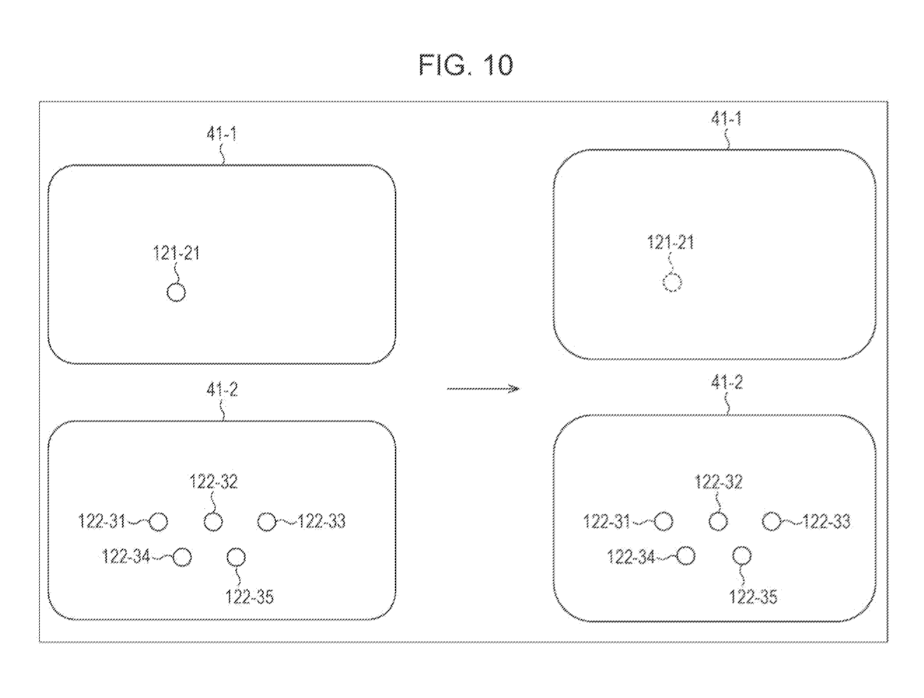

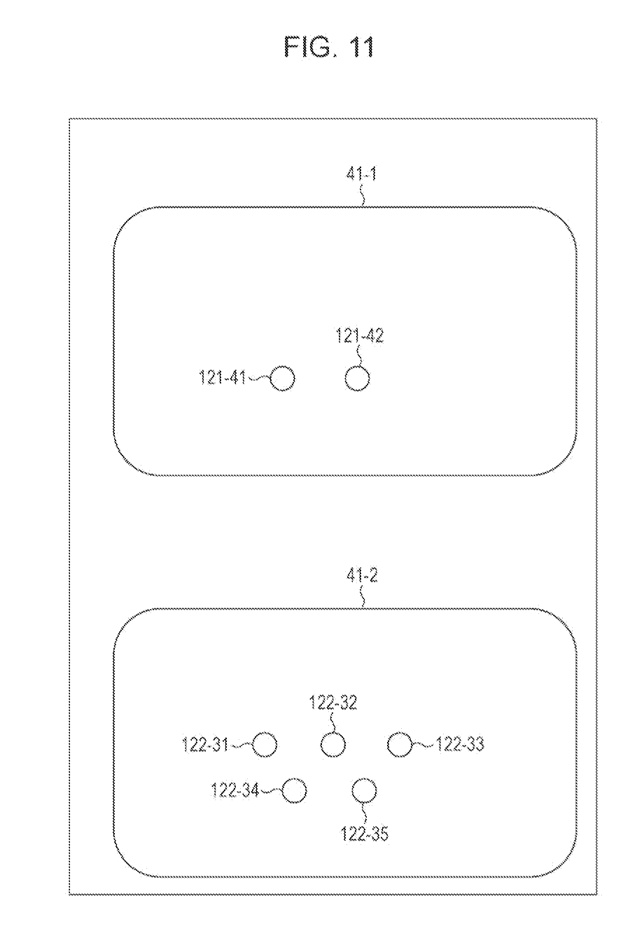

If it is determined in step S1 that touch information on the touch panel 41-1 on the upper side has changed, the processing proceeds to step S2. Referring to FIGS. 10 and 11, a case where touch information on the touch panel 41-1 on the upper side changes will be described.

FIG. 10 is a diagram showing an example of input and output of the touch panel 41 in the initial state. FIG. 11 is a diagram showing an example of input of the touch panel 41.

The left-hand side of FIG. 10 is a diagram showing the state of input of the touch panel 41. The left-hand side of FIG. 10 shows a state in which the touch panel 41-1 on the upper side has detected an upper-side touch point 121-21, and the touch panel 41-2 on the lower side has detected lower-side touch points 122-31 to 122-35.

That is, in the state on the left-hand side of FIG. 10, a single point on the touch panel 41-1 on the upper side is touched by the user, and five points on the touch panel 41-2 on the lower side are touched.

The right-hand side of FIG. 10 is a diagram showing the state of output of the touch panel 41. The right-hand side of FIG. 10 shows a state in which the touch panel 41-1 on the upper side does not output the upper-side touch point 121-21, and the touch panel 41-2 on the lower side outputs the lower-side touch points 122-31 to 122-35.

That is, the upper-side touch point 121-21 on the touch panel 41-1 on the upper side is ignored, and indicated by a broken line (that is, not displayed). In the case of such an initial state in FIG. 10, 0 is recorded as the previous upper-side output count, 5 is recorded as the previous lower-side output count.

Then, in the initial state in FIG. 10, when the number of upper-side touch points 121 detected by the touch panel 41-1 on the upper side has increased by 1, for example, when the number of fingers being touched on the touch panel 41-1 on the upper side by the user has increased from 1 to 2, the state of input of the touch panel 41 changes as shown in FIG. 11.

FIG. 11 is a diagram showing an example of input of the touch panel 41. In the example of FIG. 11, upper-side touch points 121-41 and 121-42 are detected by the touch panel 41-1 on the upper side, and lower-side touch points 122-31 to 122-35 are detected by the touch panel 41-2 on the lower side.

When the initial state in FIG. 10 transitions to the state in FIG. 11 in this way, the number of upper-side touch points 121 detected by the touch panel 41-1 on the upper side changes from 1 to 2. Thus, it is determined by the process of step S1 in FIG. 9 that touch information on the touch panel 41-1 on the upper side has changed.

When it is determined by the process of step S1 in FIG. 9 that touch information on the touch panel 41-1 on the upper side has changed in this way, in step S2, the personal computer 1 executes an upper-side rearrangement process. Referring to FIG. 12, the upper-side rearrangement process will be described.

### [Upper-Side Rearrangement Process]

FIG. 12 is a flowchart illustrating an upper-side rearrangement process by the personal computer 1.

In step S21, the acquiring section 62 acquires touch information from the touch panel 41-1 on the upper side. That is, in the example of FIG. 11, information on each of the upper-side touch points 121-41 and 121-42 is acquired as touch information.

In step S22, the recording section 63 records the number of upper-side touch points 121 in the upper-side output count and the upper-side touch count. That is, in the example of FIG. 11, 2 as the number of upper-side touch points 121 is substituted into the upper-side output count and the upper-side touch count.

The upper-side output count is a value indicating the number of upper-side touch points 121 outputted to the touch panel 41-1 on the upper side or the application 83.

The upper-side touch count is a value indicating the number of upper-side touch points 121 detected by the touch panel 41-1 on the upper side. That is, this value indicates the number of points that have been actually touched by the user.

In step S23, the control section 64 rearranges touch information in the order of being touched. Touch information may not necessarily be acquired in the order of being touched. Therefore, information on each of the upper-side touch points 121 acquired is rearranged in the order of being touched.

For example, in a case where the upper-side touch point 121-42 is touched after the upper-side touch point 121-41 is touched, touch information is rearranged in the order of the upper-side touch point 121-41 and the upper-side touch point 121-42.

It should be noted that in cases where it is guaranteed that the upper-side touch points 121 are arranged in the order of being touched, the process of step S23 can be omitted.

In step S24, the recording section 63 records the touch information rearranged by the process of step S23, in upper-side detection information. After the process of step S24, the upper-side rearrangement process ends, and the processing proceeds to step S3 in FIG. 9.

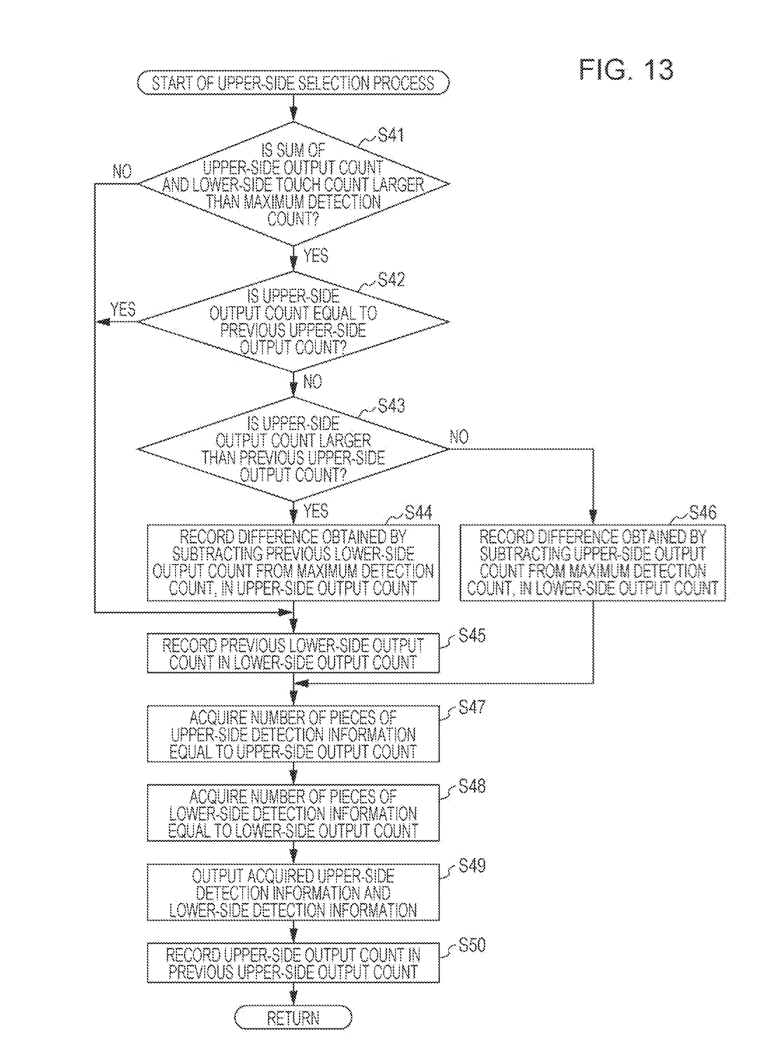

In step S3 in FIG. 9, the personal computer 1 executes an upper-side selection process. Referring to FIG. 13, the upper-side selection process will be described.

### [Upper-Side Selection Process]

FIG. 13 is a flowchart illustrating an upper-side selection process by the personal computer 1.

In step S41, the determining section 61 determines whether or not the sum of the upper-side output count and the lower-side touch count is larger than the maximum detection count. At the timing of the process of step S41, the upper-side output count becomes the same as the number of upper-side touch points 121 recorded by the process of step S22 in FIG. 12.

That is, it is determined by the process of step S41 whether or not the total sum of the number of upper-side touch points 121 detected by the touch panel 41-1 on the upper side, and the number of lower-side touch points 122 detected by the touch panel 41-2 on the lower side exceeds the maximum detection count.

In the example of FIG. 11, since the upper-side output count, that is, the number of upper-side touch points 121 is 2, and the lower-side touch count is 5, the sum of the upper-side output count and the lower-side touch count becomes 7. Therefore, the sum of the upper-side output count and the lower-side touch count is larger than the maximum detection count of 5.

If it is determined in step S41 that the sum of the upper-side output count and the lower-side touch count is larger than the maximum detection count, in step S42, the determining section 61 determines whether or not the upper-side output count is equal to the previous upper-side output count.

In the example of FIG. 11, the upper-side output count is 2, and the previous upper-side output count is 0 as shown in FIG. 10. Thus, the upper-side output count and the previous upper-side output count take different numerical values.

If it is determined in step S42 that the upper-side output count is not equal to the previous upper-side output count, in step S43, the determining section 61 determines whether or not the upper-side output count is larger than the previous upper-side output count.

That is, it is determined whether or not the number of upper-side touch points 121 detected by the touch panel 41-1 on the upper side has increased or decreased.

As shown in FIG. 10, the previous upper-side output count is 0. Thus, in the example of FIG. 11, the upper-side output count is larger than the previous upper-side output count.

If it is determined in step S43 that the upper-side output count is larger than the previous upper-side output count, in step S44, the recording section 63 records the difference obtained by subtracting the previous lower-side output count from the maximum detection count, in the upper-side output count.

That is, if the number of upper-side touch points 121 has increased, the number of upper-side touch points 121 outputted to the touch panel 41-1 on the upper side is adjusted within a range not exceeding the maximum detection count.

In the initial state in FIG. 10, the previous lower-side output count is 5, so the difference obtained by subtracting the previous lower-side output count from the maximum output count is 0. Therefore, 0 is substituted into the upper-side output count.

That is, since the maximum detection count is already reached, even when the number of touch points on the touch panel 41-1 on the upper side increases, this is ignored.

If it is determined in step S41 that the sum of the upper-side output count and the lower-side touch count is equal to or less than the maximum detection count, if it is determined in step S42 that the upper-side output count is equal to the previous upper-side output count, and after the process of step S44, the processing proceeds to step S45.

In step S45, the recording section 63 records the previous lower-side output count in the lower-side output count. In the initial state in FIG. 10, the previous lower-side output count is 5, so 5 is substituted into the lower-side output count. That is, the number of lower-side output points outputted to the touch panel 41-2 on the lower side does not change.

On the other hand, if it is determined in step S43 that the upper-side output count is smaller than the previous upper-side output count, in step S46, the recording section 63 records the difference obtained by subtracting the upper-side output count from the maximum detection count, in the lower-side output count.

That is, if the number of upper-side touch points 121 has decreased, the number of lower-side touch points 122 outputted to the touch panel 41-2 on the lower side is adjusted within a range not exceeding the maximum detection count.

After the process of either step S45 or S46, in step S47, the acquiring section 62 acquires a number of pieces of upper-side detection information equal to the upper-side output count. That is, information on each of the upper-side touch points 121 to be outputted is selected.

In the example of FIG. 11, the upper-side output count is 0, and thus no upper-side detection information is acquired. That is, touches on the upper-side touch points 121-41 and 121-42 on the touch panel 41-1 on the upper side are ignored.

In step S48, the acquiring section 62 acquires a number of pieces of lower-side detection information equal to the lower-side output count. That is, information on each of the lower-side touch points 122 to be outputted is selected.

In the example of FIG. 11, the lower-side output count is 5. Thus, information on each of five lower-side touch points 122, that is, information on each of the lower-side touch points 122-31 to 122-35 is acquired from the lower-side detection information.

Incidentally, it is assumed that in the lower-side detection information, information on each of the lower-side touch points 122-31 to 122-35 that have been rearranged in the order of being touched is recorded in advance. That is, it is assumed that the processes of steps S63 and S64 in FIG. 16 described later have been already executed.

In this way, through the processes of steps S47 and S48, even when the total sum of the number of touch points detected by the touch panels 41-1 and 41-2 has exceeded the maximum detection count, a number of pieces of touch information equal to or less than the maximum detection count can be selected.

In step S49, the output section 65 outputs the acquired upper-side detection information and lower-side detection information. That is, the upper-side detection information and the lower-side detection information acquired by the processes of steps S47 and S48 are outputted to at least one of the touch panel 41 and the application 83.

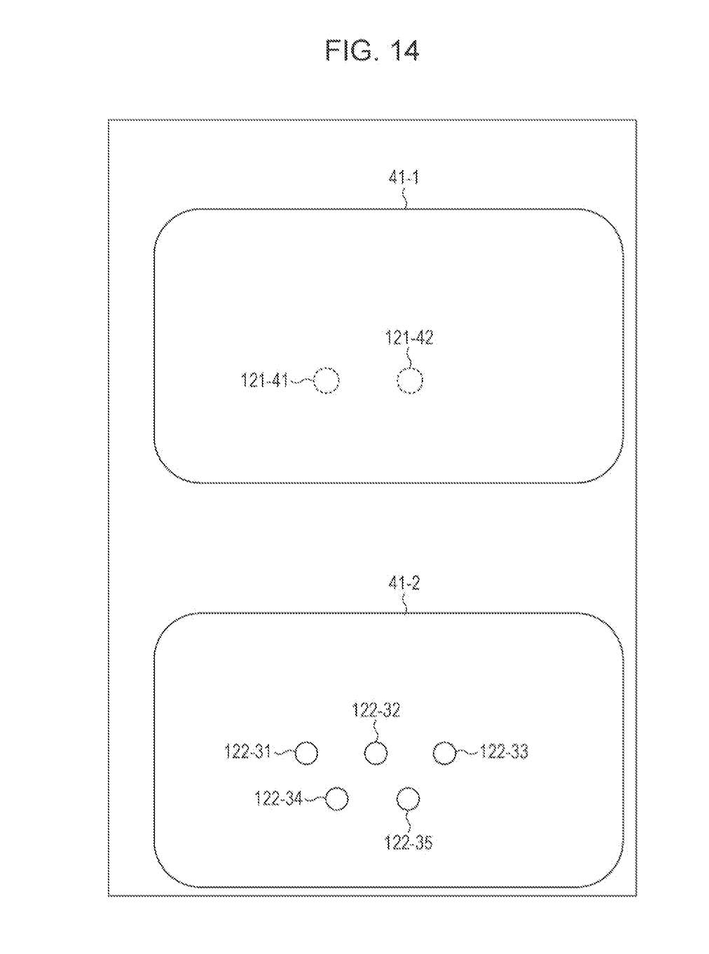

Referring to FIG. 14, a description will be given of a case where touch points are outputted to the touch panel 41 on the basis of the acquired lower-side detection information and upper-side detection information.

FIG. 14 is a diagram showing an example of output corresponding to the input of the touch panel 41 in FIG. 11.

As shown in FIG. 14, on the touch panel 41-1 on the upper side, the upper-side touch points 121-41 and 121-42 are indicated by broken lines. That is, touches on the touch panel 41-1 on the upper side are ignored, and the upper-side touch points 121-41 and 121-42 are not displayed.

Also, on the touch panel 41-2 on the lower side, the lower-side touch points 122-31 to 122-35 are indicated by solid lines. That is, on the touch panel 41-2 on the lower side, five points are determined as being touched, and the lower-side touch points 122-31 to 122-35 are displayed.

Returning to FIG. 13, in step S50, the recording section 63 records the upper-side output count in the previous upper-side output count. As shown in FIG. 14, the upper-side output count is 0, so 0 is substituted into the previous upper-side output count.

After the process of step S50, the upper-side selection process ends, and the processing returns to step S1 in FIG. 9.

In this way, when touch information on the touch panel 41-1 on the upper side has changed, appropriate touch points are selected, thereby making it possible to reliably execute processing.

Returning to FIG. 9, if it is determined in step S1 that touch information on the touch panel 41-1 on the upper side has not changed, in step S4, the determining section 61 determines whether or not touch information on the touch panel 41-2 on the lower side has changed.

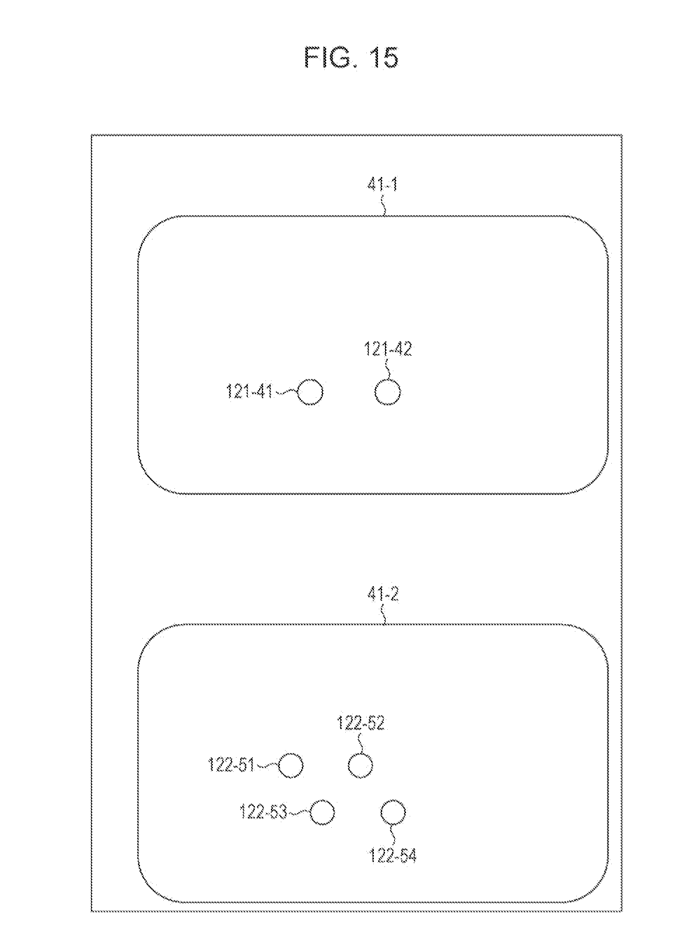

If it is determined in step S4 that touch information on the touch panel 41-2 on the lower side has changed, the processing proceeds to step S5. Referring to FIGS. 11 and 15, a description will be given of a case where touch information on the touch panel 41-1 on the lower side has changed.

In the state in FIG. 11, two points on the touch panel 41-1 on the upper side are touched by the user, and five points on the touch panel 41-2 on the lower side are touched.

In the state in FIG. 11, when the number of lower-side touch points 122 detected by the touch panel 41-2 on the lower side has decreased by 1, for example, when the number of fingers being touched by the user on the touch panel 41-2 on the lower side has decreased from 5 to 4, the state of the touch panel 41 becomes as shown in FIG. 15.

FIG. 15 is a diagram showing an example of input of the touch panel 41. The example of FIG. 15 shows a state in which the touch panel 41-1 on the upper side has detected the upper-side touch points 121-41 and 121-42, and the touch panel 41-2 on the lower side has detected lower-side touch points 122-51 to 122-54.

That is, in the state in FIG. 15, two points on the touch panel 41-1 on the upper side are touched by the user, and four points on the touch panel 41-2 on the lower side are touched.

When the state transitions from FIG. 11 to FIG. 15 in this way, the number of upper-side touch points 122 detected by the touch panel 41-2 on the lower side changes from 5 to 4. Thus, by the process of step S4 in FIG. 9, it is determined that touch information on the touch panel 41-2 on the lower side has changed.

Then, in step S5 in FIG. 9, the personal computer 1 executes a lower-side rearrangement process. Referring to FIG. 16, the lower-side rearrangement process will be described.

### [Lower-Side Rearrangement Process]

FIG. 16 is a flowchart illustrating a lower-side rearrangement process by the personal computer 1. It should be noted that the processes of steps S61 to S64 in FIG. 16 are processes corresponding to steps S21 to S24 in FIG. 12.

Specifically, the difference is that what is described as “upper-side” in steps S21, S22, and S24 in FIG. 12 is described as “lower-side” in steps S61, S62, and S64 in FIG. 16, and other processes are the same. Therefore, these processes will be described briefly to avoid repetition.

In step S61, the acquiring section 62 acquires touch information from the touch panel 41-2 on the lower side. That is, in the example of FIG. 15, information on each of the lower-side touch points 122-51 and 122-54 is acquired as touch information.

In step S62, the recording section 63 records the number of lower-side touch points 122 in the lower-side output count and the lower-side touch count. That is, in the example of FIG. 15, 4 as the number of lower-side touch points 122 is substituted into the lower-side output count and the lower-side touch count.

The lower-side output count is a value indicating the number of lower-side touch points 122 outputted to the touch panel 41-2 on the lower side or the application 83. The lower-side touch count is a value indicating the number of lower-side touch points 122 detected by the touch panel 41-2 on the lower side.

In step S63, the control section 64 rearranges touch information in the order of being touched. In the example of FIG. 15, touch information is rearranged in the order of the lower-side touch points 122-51, 122-52, 122-53, and 122-54.

It should be noted that in cases where it is guaranteed that the lower-side touch points 122 are arranged in the order of being touched, the process of step S63 can be omitted.

In step S64, the recording section 63 records the touch information rearranged by the process of step S63, in lower-side detection information. After the process of step S64, the lower-side rearrangement process ends, and the processing proceeds to step S6 in FIG. 9.

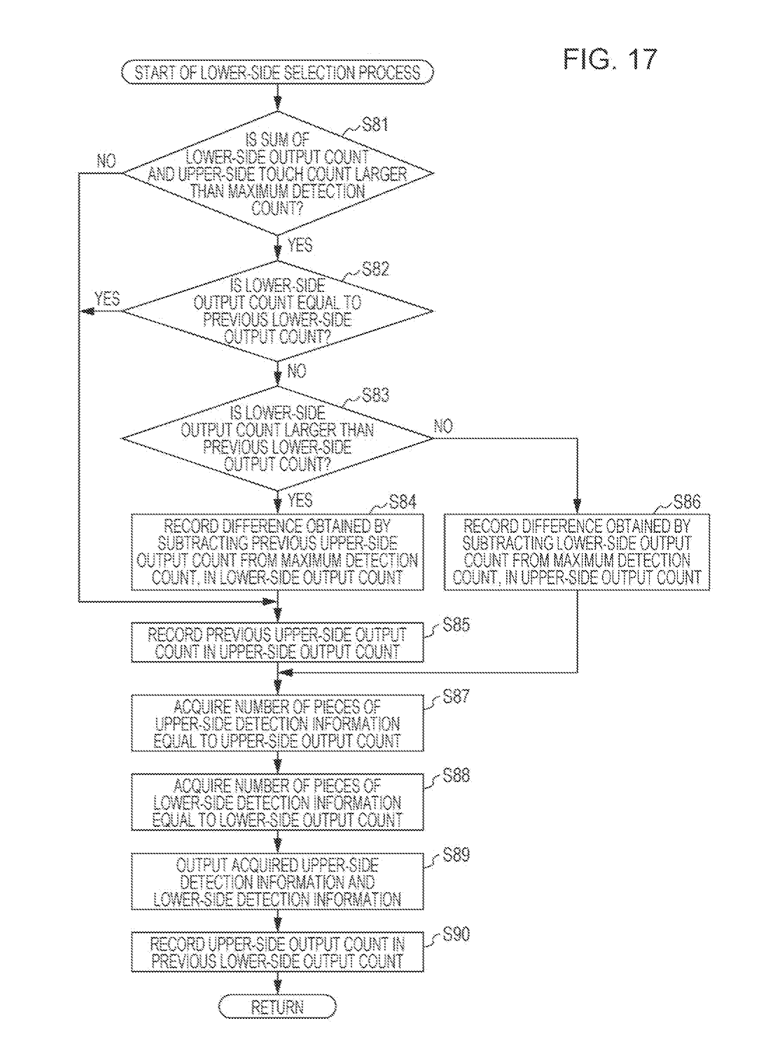

In step S6 in FIG. 9, the personal computer executes a lower-side selection process. Referring to FIG. 17, the lower-side selection process will be described.

### [Lower-Side Selection Process]

FIG. 17 is a flowchart illustrating a lower-side selection process by the personal computer 1. It should be noted that the processes of steps S81 to S90 in FIG. 17 are processes corresponding to steps S41 to S50 in FIG. 13.

Specifically, the difference is that what is described as “upper-side” in steps S41 to S46, and S50 in FIG. 13 is described as “lower-side” in steps S81 to S86, and S90 in FIG. 17, and other processes are the same. Therefore, these processes will be described briefly to avoid repetition.

In step S81, the determining section 61 determines whether or not the sum of the upper-side output count and the lower-side touch count is larger than the maximum detection count.

In the example of FIG. 15, since the lower-side output count, that is, the number of lower-side touch points 122 is 4, and the upper-side touch count is 2, the sum of the lower-side output count and the upper-side touch count becomes 6. Therefore, the sum of the lower-side output count and the upper-side touch count is larger than the maximum detection count of 5.

If it is determined in step S81 that the sum of the lower-side output count and the upper-side touch count is larger than the maximum detection count, in step S82, the determining section 61 determines whether or not the lower-side output count is equal to the previous lower-side output count.

In the example of FIG. 15, the lower-side output count is 4, and the previous lower-side output count is 5 as shown in FIG. 14. Thus, the lower-side output count and the previous lower-side output count take different numerical values.

If it is determined in step S82 that the lower-side output count is not equal to the previous lower-side output count, in step S83, the determining section 61 determines whether or not the lower-side output count is larger than the previous lower-side output count.

As shown in FIG. 11, since the previous lower-side output count is 5, the lower-side output count is smaller than the previous lower-side output count.

If it is determined in step S83 that the lower-side output count is larger than the previous lower-side output count, in step S84, the recording section 63 records the difference obtained by subtracting the previous upper-side output count from the maximum detection count, in the lower-side output count.

That is, if the number of lower-side touch points 122 has increased, the number of lower-side touch points 122 outputted to the touch panel 41-2 on the lower side is adjusted within a range not exceeding the maximum detection count.

If it is determined in step S81 that the sum of the lower-side output count and the upper-side touch count is equal to or less than the maximum detection count, if it is determined in step S82 that the lower-side output count is equal to the previous lower-side output count, and after the process of step S84, the processing proceeds to step S85.

In step S85, since the upper-side output count has not changed, the recording section 63 records the previous upper-side output count in the upper-side output count.

On the other hand, if it is determined in step S83 that the lower-side output count is smaller than the previous lower-side output count, in step S86, the recording section 63 records the difference obtained by subtracting the lower-side output count from the maximum detection count, in the upper-side output count.

That is, if the number of lower-side touch points 122 has decreased, the number of upper-side touch points 121 outputted to the touch panel 41-1 on the upper side is adjusted within a range not exceeding the maximum detection count.

In the example of FIG. 15, the lower-side output count is 4. Thus, the difference obtained by subtracting the lower-side output count from the maximum detection count of 5 becomes 1. Therefore, 1 is substituted into the upper-side output count.

After the process of either step S85 or S86, in step S87, the acquiring section 62 acquires a number of pieces of upper-side detection information equal to the upper-side output count. That is, information on each of the lower-side touch points 122 to be outputted is selected.

In the example of FIG. 15, the upper-side output count is 1. Thus, information on a single upper-side touch point 121, that is, information on the upper-side touch point 121-41 is acquired from the upper-side detection information.

In step S88, the acquiring section 62 acquires a number of pieces of lower-side detection information equal to the lower-side output count. In the example of FIG. 15, the lower-side output count is 4. Thus, information on each of four lower-side touch points 122, that is, information on each of the lower-side touch points 122-51 to 122-54 is acquired from the lower-side detection information.

In step S89, the output section 65 outputs the acquired upper-side detection information and lower-side detection information. That is, the upper-side detection information and the lower-side detection information acquired by the processes of steps S87 and S88 are outputted to at least one of the touch panel 41 and the application 83.

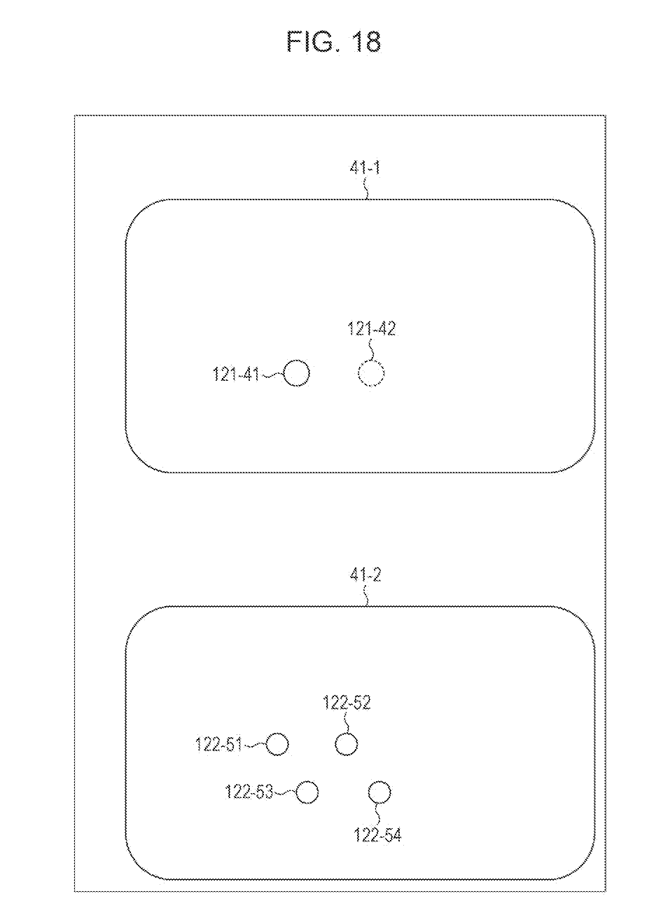

Referring to FIG. 18, a description will be given of a case where the acquired upper-side detection information and lower-side detection information are outputted.

FIG. 18 is a diagram showing an example of output corresponding to the input of the touch panel 41 in FIG. 15. As shown in FIG. 18, on the touch panel 41-1 on the upper side, the upper-side touch point 121-41 is indicated by a solid line, and the upper-side touch point 121-42 are indicated by a broken line.

That is, on the touch panel 41-1 on the upper side, a single point is determined as being touched, and the upper-side touch point 121-41 is displayed and the upper-side touch point 121-42 is not displayed.

Also, on the touch panel 41-2 on the lower side, the lower-side touch points 122-51 to 122-54 are indicated by solid lines. That is, on the touch panel 41-2 on the lower side, four points are determined as being touched, and the lower-side touch points 122-51 to 122-54 are displayed.

Returning to FIG. 17, in step S90, the recording section 63 records the lower-side output count in the previous lower-side output count. As shown in FIG. 18, the lower-side output count is 4, so 4 is substituted into the previous lower-side output count.

After the process of step S90, the upper-side selection process ends, and the processing returns to step S1 in FIG. 9.

Thus, the personal computer 1 can reliably execute more diverse processing while combining and regarding the touch panel 41-1 and the touch panel 41-2 as a single touch panel.

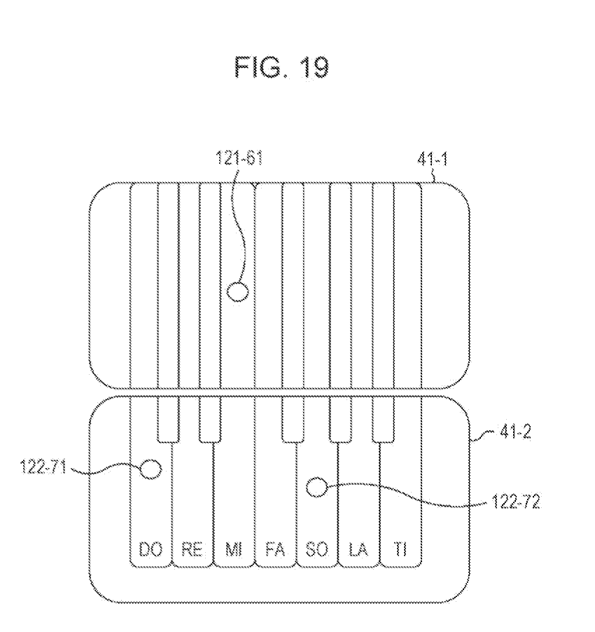

Next, referring to FIG. 19, a description will be given of a case where upper-side detection information and lower-side detection information are outputted to the application 83.

FIG. 19 is a diagram showing an example of processing by the application 83. The example of FIG. 19 shows an application that executes playing of a piano.

An upper-side touch point 121-61 and lower-side touch points 122-71 and 122-72 in FIG. 19 are displayed.

On the touch panel 41-1 on the upper side in FIG. 19, the upper-side touch point 121-61 is displayed on the image of the key “mi”.

Also, on the touch panel 41-2 on the lower side, the lower-side touch point 122-71 is displayed on the image of the key “do”, and the lower-side touch point 122-72 is displayed on the image of the key “so”.

Therefore, in the example of FIG. 19, a chord of “do”, “mi”, and “so” is outputted by the application 83.

Of course, while the chord of “do”, “mi”, and “so” is outputted also when the key “mi” on the touch panel 41-2 on the lower side is operated, since the touch panel 41-1 on the upper side and the touch panel 41-2 on the lower side are handled integrally in the present disclosure, the chord is outputted in this case as well.

In this way, predetermined processing can be executed reliably on the basis of the upper-side touch points 121 and the lower-side touch points 122 selected so as to be equal to or less than the maximum detection count of touch points.

### [Others]

In this specification, the term system means an entire apparatus made up of a plurality of apparatuses, means, or the like.

An embodiment of the present disclosure is not limited to the above-mentioned embodiment, but various changes are possible without departing from the scope of the present disclosure. Also, in the embodiment of the present disclosure, some of functions may be included in another apparatus.

It should be noted that while the embodiment of the present disclosure is directed to the case where the touch panel 41 is installed on each of the upper side and the lower side, the positions to place such two touch panels 41 are not limited to these.

Also, while in the embodiment of the present disclosure the maximum detection count is set as 5, the maximum detection count can be set as, for example, the smaller one of the maximum detection count for the software that controls the touch panel 41-1 and the maximum detection count for the software that controls the touch panel 41-2. Alternatively, the maximum detection count may be set to an arbitrary number by the application or the like.

Further, while in the embodiment of the present disclosure the upper-side touch points 121 and the lower-side touch points 122 are displayed on the touch panel 41, the upper-side touch points 121 and the lower-side touch points 122 may not be displayed on the touch panel 41.

Furthermore, while in the embodiment of the present disclosure the touch panel 41 is formed by integrating an input device and an output device, another display apparatus may be used as an output device, and the touch panel 41 may have only the function of an input device.

Other than personal computers, the present disclosure can be also applied to information processing apparatuses such as smartphones, tablets, and digital signage.

It should be understood that, as used herein, the indefinite articles “a” and “an” mean “one or more” in open-ended claims containing the transitional phrase “comprising,” “including,” or “having.”

It should be noted that the present disclosure can also take the following configurations.

(1) An information processing apparatus including a plurality of touch panels that detect touch information, and a control section that performs control so as to execute predetermined processing, while handling the touch information detected by the plurality of touch panels as touch information detected by a single touch panel.

(2) The information processing apparatus according to (1) mentioned above, further including an acquiring section that acquires the touch information, in which the acquiring section acquires a number of pieces of the touch information equal to or less than a maximum detection count, when a total sum of pieces of the touch information detected by the plurality of touch panels exceeds the maximum detection count, and the control section performs control so as to execute the predetermined processing, on a basis of the number of pieces of the touch information equal to or less than the maximum detection count which are acquired by the acquiring section.

(3) The information processing apparatus according to (2) mentioned above, in which the control section rearranges the touch information detected by the plurality of touch panels in an order of being touched for each of the touch panels, and the acquiring section acquires sequentially from the touch information that is touched earliest.

(4) The information processing apparatus according to any one of (1) to (3) mentioned above, in which the plurality of touch panels include a first touch panel and a second touch panel, and the control section adjusts a number of pieces of the touch information on the first touch panel, when the number of pieces of the touch information on the first touch panel has increased, or when a number of pieces of the touch information on the second touch panel has decreased, and adjusts the number of pieces of the touch information on the second touch panel, when the number of pieces of the touch information on the first touch panel has decreased, or when the number of pieces of the touch information on the second touch panel has increased.

(5) The information processing apparatus according to any one of (2) to (4) mentioned above, in which the maximum detection count is set as a smaller one of a maximum detection count for the first touch panel and a maximum detection count for the second touch panel.

### EXPLANATION OF REFERENCE NUMERALS

1 personal computer, 41 touch panel, 62 acquiring section, 64 control section.

1. A method for identifying a subset of touch positions, comprising:
receiving, from a first touch input device, first touch information comprising first positional information identifying one or more first device positions touched by a user;
receiving, from a second touch input device, second touch information comprising second positional information identifying one or more second device positions touched by the user;
identifying, based on the first and second touch information, a subset of the first and second device positions as detected positions; and
sending detection information identifying the detected positions to an application.

2. The method of claim 1, wherein:
the first touch information comprises first device information identifying the first input device; and
the second touch information comprises second device information identifying the second input device.

3. The method of claim 1, wherein:
the first positional information comprises first spatial coordinates of the first device positions; and
the second positional information comprises second spatial coordinates of the second device positions.

4. The method of claim 1, wherein:
the first touch information comprises first time information identifying a first temporal order of the first device positions; and
the second touch information comprises second time information identifying a second temporal order of the second device positions.

5. The method of claim 1, wherein identifying comprises identifying a quantity of the detected positions which is less than or equal to a predetermined value.

6. The method of claim 1, wherein identifying comprises identifying the detected positions based on the first and second time information.

7. The method of claim 1, wherein identifying comprises identifying as the detected positions ones of the first and second device positions which were touched earliest in time.

8. The method of claim 1, comprising sending, from the application, output data to a display device causing the display device to display images corresponding to the detected positions.

9. Apparatus for providing a user interface, comprising:
a hardware processor; and
a memory coupled to the processor and containing instructions which, when executed by the processor, cause the apparatus to:
receive, from a first touch input device, first touch information comprising first positional information identifying one or more first device positions touched by a user;
receive, from a second touch input device, second touch information comprising second positional information identifying one or more second device positions touched by the user;
identify, based on the first and second touch information, a subset of the first and second device positions as detected positions; and
send detection information identifying the detected positions to an application.

10. The apparatus of claim 9, wherein:
the first touch information comprises first device information identifying the first input device; and
the second touch information comprises second device information identifying the second input device.

11. The apparatus of claim 9, wherein:
the first positional information comprises first spatial coordinates of the first device positions; and
the second positional information comprises second spatial coordinates of the second device positions.

12. The apparatus of claim 9, wherein:
the first touch information comprises first time information identifying a first temporal order of the first device positions; and
the second touch information comprises second time information identifying a second temporal order of the second device positions.

13. The apparatus of claim 9, wherein identifying comprises identifying a quantity of the detected positions which is less than or equal to a predetermined value.

14. The apparatus of claim 9, wherein identifying comprises identifying the detected positions based on the first and second time information.

15. The apparatus of claim 9, wherein identifying comprises identifying as the detected positions ones of the first and second device positions which were touched earliest in time.

16. A non-transitory, computer-readable medium storing instructions which, when executed by a processor, cause a user interface to perform a method comprising:
receiving, from a first touch input device, first touch information comprising first positional information identifying one or more first device positions touched by a user;
receiving, from a second touch input device, second touch information comprising second positional information identifying one or more second device positions touched by the user;
identifying, based on the first and second touch information, a subset of the first and second device positions as detected positions; and
sending detection information identifying the detected positions to an application.

17. The computer-readable medium of claim 16, storing instructions of the application, the application instructions, when executed by a processor, causing a display device to display images corresponding to the detected positions.

18. Apparatus for providing a user interface, comprising:
means for receiving, from a first touch input device, first touch information comprising first positional information identifying one or more first device positions touched by a user;
means for receiving, from a second touch input device, second touch information comprising second positional information identifying one or more second device positions touched by the user;
means for identifying, based on the first and second touch information, a subset of the first and second device positions as detected positions; and
means for sending detection information identifying the detected positions to an application.

19. Apparatus for providing a user interface, comprising:
a first touch input device generating first touch information comprising first positional information identifying one or more first device positions touched by a user;
a second touch input device generating second touch information comprising second positional information identifying one or more second device positions touched by the user;
a display device; and
a control unit, the control unit:
identifying, based on the first and second touch information, a subset of the first and second device positions as detected positions; and
sending to the display device instructions to cause the display device to display images corresponding to the detected positions.
